(19) United States
(12) Patent Application Publication
(10) Pub. No.: US 2003/0041331 A1
(43) Pub. Date: Feb. 27, 2003

(54) System and method for mitigating interruptions during television viewing

(76) Inventors: Paul G. Allen, Mercer Island, WA (US); John M. Kellum, Seattle, WA (US); Robert E. Novak, Kirkland, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/933,880

(22) Filed: Aug. 21, 2001

(51) Int. Cl. H04N 7/173

(52) U.S. Cl. 725/106; 725/122

(57) ABSTRACT

In response to an incoming communication request or other interruption, a television signal being currently displayed by an interactive television system is buffered for subsequent playback. In one embodiment, the television signal is automatically buffered immediately upon detection of the request. Alternatively, buffering begins when the request is accepted. Playback of the television signal being buffered may commence, for example, when the request is rejected or after communication with a remote device is terminated.

### BACKGROUND

1. Field of the Invention

The present invention relates generally to the field of interactive television systems. More specifically, the present invention relates to a system and method for automatically buffering television signals to mitigate interruptions during viewing of television broadcasts.

2. Description of Related Background Art

Modern interactive television systems allow users to do much more than simply watch television. Today, users can view television broadcasts while checking stock prices, booking flights, or engaging in two-way audio, video, or text-based communication with other similarly-equipped users.

Unfortunately, many of these new features interrupt the television viewing experience. For example, a user may be intently watching a television broadcast when a request is received from another party to establish two-way video communication. Whether the user accepts or rejects the request, he or she will likely miss at least a portion of the television broadcast while responding to the interruption.

Such interruptions can range in time from a few second to several minutes or hours. Unfortunately, the television broadcast continues, heedless of interruption. Unless the user has ready access to a recording device, such as a VCR, he or she may miss a significant portion of the broadcast while responding to the interruption. Even if the user has a recording device, he or she may not have sufficient time to program (or may incorrectly program) the recording device to record the broadcast. For example, in the rush to answer an incoming communication request, the user may fail to press the record button on the VCR.

Interruptions can be very annoying and even costly in the case of expensive pay-per-view (PPV) or Video-on-Demand (VoD) programs. Currently, no system and method exists for ensuring that portions of a television broadcast or other entertainment program are not missed due to communication requests or other interruptions.

Accordingly, what is needed is a system and method for mitigating interruptions during television viewing. What is also needed is a system and method for allowing a user to respond to an interruption, such as a communication request, and still be able to view the currently-displayed television broadcast in its entirety.

### BRIEF DESCRIPTION OF THE DRAWINGS

Non-exhaustive embodiments of the invention are described with reference to the figures, in which:

FIG. 1 is a block diagram of a communication system;

FIG. 2 is an illustration of an interactive television system;

FIG. 3 is a block diagram of physical components of a set top box (STB);

FIG. 4 is a dataflow diagram illustrating the interception of a communication request;

FIG. 5 is a dataflow diagram illustrating the buffering of a television signal during two-way communication;

FIG. 6 is a dataflow diagram illustrating the playback of a buffered television program;

FIG. 7 is a timing diagram illustrating a buffering process;

FIG. 8 is a block diagram of logical components of a system for mitigating interruptions during television viewing;

FIG. 9 illustrates a user interface for accepting or rejecting a communication request;

FIG. 10 is a block diagram of logical components of an alternative system for mitigating interruptions during television viewing; and

FIGS. 11 and 12 are flowcharts of methods for mitigating interruptions during television viewing.

### DETAILED DESCRIPTION OF THE PREFERRED EMBODIMENTS

The present invention solves the foregoing problems and disadvantages by providing a system and method for mitigating interruptions during television viewing, particularly with respect to interruptions caused by incoming communication requests.

In one implementation, a request to establish communication with a remote device is detected by an interactive television (ITV) system. The remote device may be another ITV system, a video phone, an audio-only telephone, or other similar device. The request may be embodied in any suitable format according to the devices and/or software being used.

In one embodiment, a television signal being currently displayed by the ITV system is automatically buffered within a storage device, such a hard disk drive, random access memory (RAM), or the like. The buffering is automatic in that a user need not activate a recording feature of the interactive television system in order to record the television signal. In one configuration, the buffering commences when the request is detected. Alternatively, the buffering may commence when the request is accepted.

A user of the ITV system is then prompted to accept or reject the request. If the user accepts the request, two-way communication is established between the ITV system and the remote device in accordance with the request using standard protocols. The communication may include two-way video, audio, or text-based communication, depending on the request and the capabilities of the devices involved.

In one configuration, after the communication is terminated, the buffered television signal is automatically played back from a point in time at which the request was detected. Alternatively, the buffered television signal is played back from a point in time at which the request was accepted. In yet another alternative embodiment, the television broadcast being buffered may be played back in response to the user rejecting the request. Thus, the interruption caused by the communication request is mitigated, and the user is allowed to watch a television broadcast in its entirety as though the interruption never occurred.

Of course, automatic buffering and playback may be overridden by a user command. For instance, in certain embodiments, a user may play back the buffered television signal during ongoing two-way communication. The user may initiate the playback, for example, by pressing a suitable button on a remote control device. In such an embodiment, a communication data (video or text) received from the remote device may be displayed in a Picture-in-Picture (PIP) window while the buffered television signal is being played back on a main window, or vice versa.

In an alternative embodiment of the invention, the ITV system is coupled to a standard telephone line. Upon detection of a ring signal on the telephone line, the ITV system buffers the television signal being displayed. The user may then answer the telephone call assured that he or she will not miss portions of a television broadcast. When the telephone call is ended, playback may resume from a point in time at which the ring signal was detected.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The following discussion makes particular reference to two-way video communication. However, those skilled in the art recognize that video communication typically includes two-way audio communication. Thus, where video communication and corresponding components are specifically illustrated, audio communication and corresponding components may be implied.

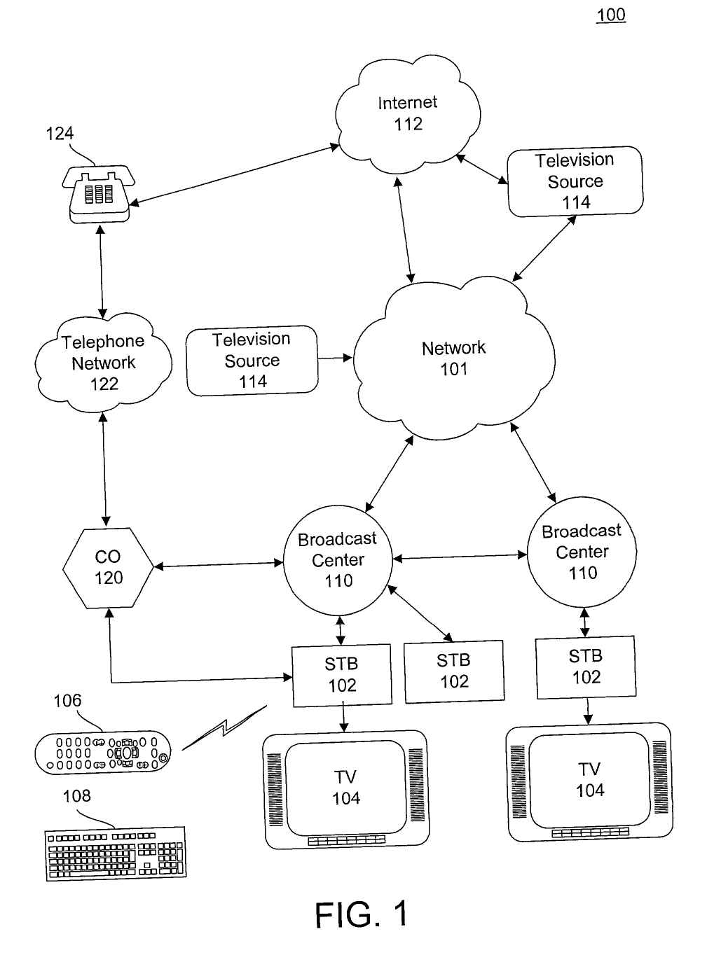

Referring now to FIG. 1, there is shown a communication system 100. In one implementation, the system 100 relies on a broadband network 101 for communication, such as a cable network or a direct satellite broadcast (DBS) network, although other networks are possible.

The system 100 may include a plurality of set top boxes (STBs) 102 located, for instance, at customer homes or offices. Generally, an STB 102 is a consumer electronics device that serves as a gateway between a customer's television 104 and the network 101. In alternative embodiments, an STB 102 may be embodied more generally as a personal computer (PC), an advanced television 104 with STB functionality, or another type of client terminal.

An STB 102 receives encoded television signals and other information from the network 101 and decodes the same for display on the television 104 or other display device, such as a computer monitor, flat panel display, or the like. As its name implies, an STB 102 is typically located on top of, or in close proximity to, the television 104.

Each STB 102 may be distinguished from other network components by a unique identifier, number, code, or address, examples of which include an Internet Protocol (IP) address (e.g., an IPv6 address), a Media Access Control (MAC) address, or the like. Thus, video streams and other information may be transmitted from the network 101 to a specific STB 102 by specifying the corresponding address, after which the network 101 routes the transmission to its destination using conventional techniques.

A remote control 106 is provided, in one configuration, for convenient remote operation of the STB 102 and the television 104. The remote control 106 may use infrared (IR), radio frequency (RF), or other wireless technologies to transmit control signals to the STB 102 and the television 104. Other remote control devices are also contemplated, such as a wired or wireless mouse (not shown).

Additionally, a keyboard 108 (either wireless or wired) is provided, in one embodiment, to allow a user to rapidly enter text information into the STB 102. Such text information may be used for e-mail, instant messaging (e.g. text-based chat), or the like. In various embodiments, the keyboard 108 may use infrared (IR), radio frequency (RF), or other wireless technologies to transmit keystroke data to the STB 102.

Each STB 102 may be coupled to the network 101 via a broadcast center 110. In the context of a cable network, a broadcast center 110 may be embodied as a “head-end”, which is generally a centrally-located facility within a community where television programming is received from a local cable TV satellite downlink or other source and packaged together for transmission to customer homes. In one configuration, a head-end also functions as a Central Office (CO) in the telecommunication industry, routing video streams and other data to and from the various STBs 102 serviced thereby.

A broadcast center 110 may also be embodied as a satellite broadcast center within a direct broadcast satellite (DBS) system. A DBS system may utilize a small 18-inch satellite dish, which is an antenna for receiving a satellite broadcast signal. Each STB 102 may be integrated with a digital integrated receiver/decoder (IRD), which separates each channel, and decompresses and translates the digital signal from the satellite dish to be displayed by the television 104.

Programming for a DBS system may be distributed, for example, by multiple high-power satellites in geosynchronous orbit, each with multiple transponders. Compression (e.g., MPEG) may be used to increase the amount of programming that can be transmitted in the available bandwidth.

The broadcast centers 110 may be used to gather programming content, ensure its digital quality, and uplink the signal to the satellites. Programming may be received by the broadcast centers 110 from content providers (CNN, ESPN, HBO, TBS, etc.) via satellite, fiber optic cable and/or special digital tape. Satellite-delivered programming is typically immediately digitized, encrypted and uplinked to the orbiting satellites. The satellites retransmit the signal back down to every earth-station, e.g., every compatible DBS system receiver dish at customers' homes and businesses.

Some broadcast programs may be recorded on digital videotape in the broadcast center 110 to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

Regardless of the nature of the network 101, the broadcast centers 110 may be coupled directly to one another or through the network 101. In alternative embodiments, broadcast centers 110 may be connected via a separate network, one particular example of which is the Internet 112. The Internet 112 is a “network of networks” and is well known to those skilled in the art. Communication over the Internet 112 is accomplished using standard protocols, such as TCP/IP (Transmission Control Protocol/Internet Protocol) and the like.

A broadcast center 110 may receive television programming for distribution to the STBs 102 from one or more television programming sources 114 coupled to the network 101. Preferably, television programs are distributed in an encoded format, such as MPEG (Moving Picture Experts Group). Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

Broadcast centers 110 may be used to enable audio and video communications between STBs 102. Transmission between broadcast centers 110 may occur (i) via a direct peer-to-peer connection between broadcast centers 110, (ii) upstream from a first broadcast center 110 to the network 101 and then downstream to a second broadcast center 110, or (iii) via the Internet 112. For instance, a first STB 102 may send a video transmission upstream to a first broadcast center 110, then to a second broadcast center 110, and finally downstream to a second STB 102.

Broadcast centers 110 and/or STBs 102 may be linked by one or more Central Offices (COs) 120, which are nodes of a telephone network 122. The telephone network 122 may be embodied as a conventional public switched telephone network (PSTN), digital subscriber line (DSL) network, cellular network, or the like. Thus, communication may be established with standard telephones 124 via the network 122. Alternatively, a telephone 124 may be configured as a “web phone”, which is coupled to the Internet 112 and uses Internet protocols for communication.

Of course, the communication system 100 illustrated in FIG. 1 is merely exemplary, and other types of devices and networks may be used within the scope of the invention.

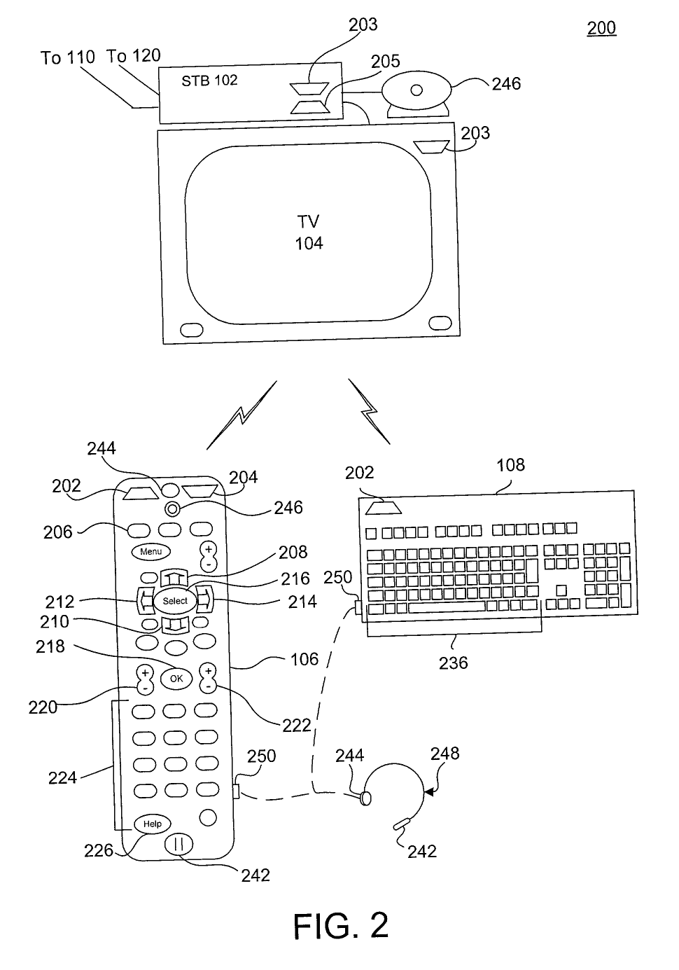

Referring now to FIG. 2, there is shown an interactive television (ITV) system 200 according to an embodiment of the invention. As depicted, the system 200 may include an STB 102, a television 104 (or other display device), a remote control 106, and, in certain configurations, a keyboard 108.

The remote control 106 is provided for convenient remote operation of the STB 102 and the television 104. In one configuration, the remote control 106 includes a wireless transmitter 202 for transmitting control signals (and possibly audio/video data) to a wireless receiver 203 within the STB 102 and/or the television 104. In certain embodiments, the remote control 106 includes a wireless receiver 204 for receiving signals from a wireless transmitter 205 within the STB 102. Operational details regarding the wireless transmitters 202, 205 and wireless receivers 203, 204 are generally well known to those of skill in the art.

The remote control 106 preferably includes a number of buttons or other similar controls. For instance, the remote control 106 may include a power button 206, an up arrow button 208, a down arrow button 210, a left arrow button 212, a right arrow button 214, a “Select” button 216, an “OK” button 218, channel adjustment buttons 220, volume adjustment buttons 222, alphanumeric buttons 224, a “Help” button 226, and the like.

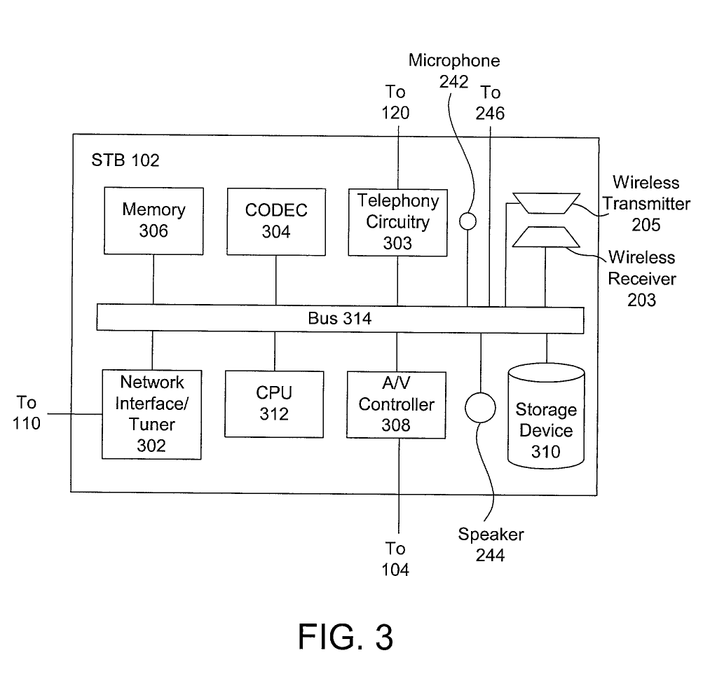

In one embodiment, the remote control 106 includes a microphone 242 for capturing audio signals. The captured audio signals are preferably transmitted to the STB 102 via the wireless transmitter 202. In addition, the remote control 106 may include a speaker 244 for generating audible output from audio signals received from the STB 102 via the wireless receiver 204. In alternative embodiments, as shown in FIG. 3, the microphone 242 and/or speaker 244 may be integrated with the STB 102.

In certain embodiments, the remote control 106 further includes a video camera 246, such as a CCD (charge-coupled device) digital video camera, for capturing video signals. In one implementation, the video camera 246 is in electrical communication with the wireless transmitter 202 for sending the captured video signals to the STB 102. Like the microphone 242 and speaker 244, the video camera 246 may be integrated with the STB 102, or attached to the STB 102, as in the depicted embodiment.

The various components of the remote control 106 may be positioned in different locations for functionality and ergonomics. For example, as shown in FIG. 2, the speaker 244 may be positioned near the “top” of the remote control 106 (when viewed from the perspective of FIG. 2) and the microphone 242 may be positioned at the “bottom” of the remote control 106. Thus, in one embodiment, a user may conveniently position the speaker 244 near the user's ear and the microphone 242 near the user's mouth in order to operate the remote control 106 in the manner of a telephone.

The optional keyboard 108 facilitates rapid composition of text messages. The keyboard 108 includes a plurality of standard alphanumeric keys 236. In one configuration, the keyboard 108 includes a wireless transmitter 202, similar or identical to the wireless transmitter 202 of the remote control 106. The wireless transmitter 202 transmits keystroke data from the keyboard 108 to the STB 102. Additionally, the keyboard 108 may include one or more of the buttons illustrated on the remote control 106.

Alternatively, or in addition, a hands-free headset 248 may be coupled to the remote control 106 or the keyboard 108. The headset 248 may be coupled using a standard headset jack 240. The headset 248 may include a microphone 242 and/or speaker 244. Such a headset 248 may be used to reduce audio interference from the television 104 (improving audio quality) and to provide the convenience of hands-free operation.

Referring now to FIG. 3, there is shown a block diagram of physical components of an STB 102 according to an embodiment of the invention. As noted above, the STB 102 includes a wireless receiver 203 for receiving control signals sent by the wireless transmitter 202 in the remote control 106 and a wireless transmitter 205 for transmitting signals (such as audio/video signals) to the wireless receiver 204 in the remote control 106.

The STB 102 also includes, in one implementation, a network interface/tuner 302 for receiving television signals and other data from the network 101 via a broadcast center 110. The interface/tuner 302 may conventional include tuning circuitry for receiving, demodulating, and demultiplexing MPEG-encoded television signals, e.g., digital cable or satellite TV signals. In certain embodiments, the interface/tuner 302 may include analog tuning circuitry for tuning to analog television signals, e.g., analog cable TV signals.

The interface/tuner 302 may also include conventional cable modem circuitry for sending or receiving data. For example, the interface/tuner 302 may conform to the DOCSIS (Data Over Cable Service Interface Specification) or DAVIC (Digital Audio-Visual Council) cable modem standards. Of course, the network interface and tuning functions could be performed by separate components within the scope of the invention.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission may be accomplished differently for different networks 101. Alternative ways to accomplish upstream transmission include using a back channel transmission, which is typically sent via an analog telephone line, ISDN, DSL, or other techniques.

The STB 102 may also include standard telephony circuitry 303. The telephony circuitry 303 may be used to establish a two-way telephone connection between the STB 102 and a conventional telephone. In one embodiment, the telephony circuitry 303 transforms an audio signal received by wireless receiver 203 of the STB 102 into a telephony-grade audio signal for transmission via the telephone network 122. Likewise, the telephony circuitry 303 may receive a telephony-grade audio signal from the telephone network 122 and generate an audio signal compatible with the wireless transmitter 205 of the STB 102 for transmission to a speaker 244 in the remote control 106, STB 102, or the television 104. Alternatively, or in addition, the telephony circuitry 303 may include analog or digital (e.g. DSL) modem circuitry to allow audio, video, text, and control data to be transmitted via the telephone network 122.

The STB 102 also preferably includes a codec (encoder/decoder) 304, which serves to encode audio/video signals into a network-compatible data stream for transmission over the network 101. The codec 304 also serves to decode a network-compatible data stream received from the network 101. The codec 304 may be implemented in hardware and/or software. Moreover, the codec 304 may use various algorithms, such as MPEG or Voice-over-IP (VoIP), for encoding and decoding.

The STB 102 further includes a memory device 306, such as a random access memory (RAM), for storing temporary data. Similarly, a read-only memory (ROM) may be provided for storing more permanent data, such as fixed code and configuration information.

In one embodiment, an audio/video (AN) controller 308 is provided for converting digital audio/video signals into analog signals for playback/display on the television 104. The A/V controller 308 may be implemented using one or more physical devices, such as separate graphics and sound controllers. The AN controller 308 may include graphics hardware for performing bit-block transfers (bit-blits) and other graphical operations for displaying a graphical user interface (GUI) on the television 104.

In some implementations, the STB 102 may include a storage device 310, such as a hard disk drive or the like. The storage device 310 may be configured to store encoded television broadcasts and retrieve the same at a later time for display. The storage device 310 may be configured, in one embodiment, as a digital video recorder (DVR), enabling scheduled recording of television programs, pausing (buffering) live video, etc. The storage device 310 may also be used in various embodiments to store viewer preferences, parental lock settings, electronic program guide (EPG) data, passwords, e-mail messages, and the like. In one implementation, the storage device 310 also stores an operating system (OS) for the STB 102, such as Windows CE® or Linux®.

As noted above, the STB 102 may include, in certain embodiments, a microphone 242 and a speaker 244 for capturing and reproducing audio signals, respectively. The STB 102 may also include or be coupled to a video camera 246 for capturing video signals. These components may be included in lieu of or in addition to similar components in the remote control 106, keyboard 108, and/or television 104.

A CPU 312 controls the operation of the STB 102, including the other components thereof, which are coupled to the CPU 312 in one embodiment via a bus 314. The CPU 312 may be embodied as a microprocessor, a microcontroller, a digital signal processor (DSP) or other device known in the art. For instance, the CPU 312 may be embodied as an Intel® x86 processor. As noted above, the CPU 312 may perform logical and arithmetic operations based on program code stored within the memory 306 or the storage device 310.

Of course, FIG. 3 illustrates only one possible configuration of an STB 102. Those skilled in the art will recognize that various other architectures and components may be provided within the scope of the invention. In addition, various standard components are not illustrated in order to avoid obscuring aspects of the invention.

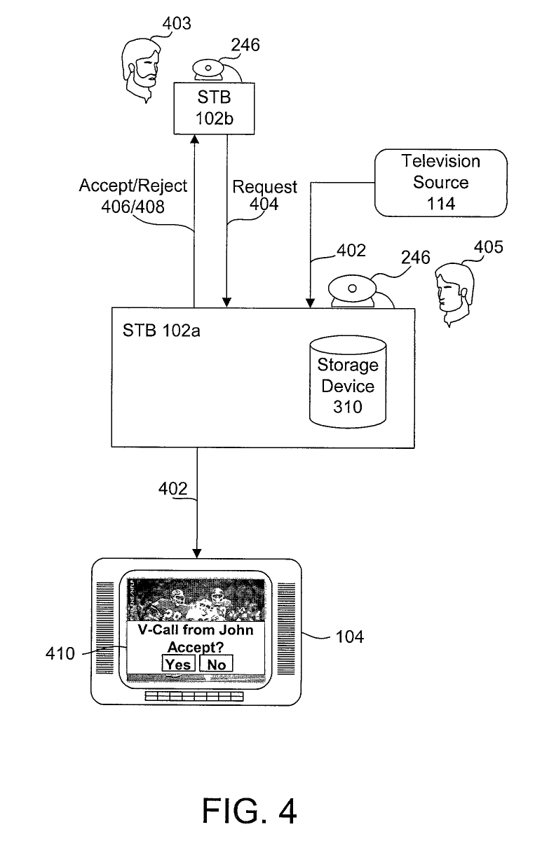

FIGS. 4-6 are high-level dataflow diagrams illustrating various operations and transactions according to embodiments of the invention. Of course, the illustrated embodiment may be modified in various ways without departing from the spirit and scope of the invention.

In one embodiment, as shown in FIG. 4, an STB 102a receives and decodes a television signal 402 sent by a television source 114. The television signal 402 is not limited to traditional broadcast television programming, but may include, for instance, PPV, VoD, or streaming video programming. Thus, the term “television signal”, as used herein, simply means that the signal 402 may be displayed, or may be adapted for display, on a television 104 or similar display device.

In one embodiment, a user of a second STB 102b, hereinafter referred to as a caller 403, attempts to establish two-way communication (e.g., audio, video, or text) with the user 405 of the first STB 102a. Of course, the caller 403 may use other types of remote devices for communication, such as a personal computer (PC), personal digital assistant (PDA), cell phone, videophone, or the like.

In one embodiment, the second STB 102b (or other remote device) sends a communication request 404 to the first STB 102a. As previously noted, the request 404 may be embodied in various forms, depending on the hardware and software being used.

Upon detecting the request 404, the first STB 102a may begin to immediately buffer or store the television signal 402. The buffering may be automatic, i.e. no user intervention is required. In one embodiment, the storage device 310 of the STB 102 is used to store the television signal 402, which is preferably encoded using MPEG-2 or another compression format. Alternatively, the memory 306 of the STB 102 could be used for the same purpose. Various systems are known for buffering or storing television signals 402 using a hard disk drive or the like, such as the system disclosed in U.S. Pat. No. 6,233,389, entitled “Multimedia Time Warping System”, which is incorporated herein by reference.

In one embodiment, the STB 102a prompts the user 405 to accept or reject the request 404. For instance, a prompt 410, such as a pop-up window, may be displayed on the television 104. As described in greater detail below, the prompt 410 may indicate the identity of the caller 403.

Preferably, the prompt 410 is sized and positioned to minimize disruption of television viewing. For example, the prompt 410 may be displayed near the top or bottom of the television screen. Moreover, the prompt 410 may be semitransparent, allowing the underlying video signal 402 to remain substantially visible.

No matter how small or inconspicuous, the prompt 410 is likely to distract the caller from viewing the television broadcast being currently displayed. Thus, buffering the television signal 402 upon detection of the request 404 is advantageous in that a user 405 may subsequently view the buffered signal 402 from the initial point of the interruption.

In an alternative embodiment, the television signal 402 is buffered from the point in time at which the user 405 accepts the request. Typically, the interruption caused by accepting a request 404 and answering a call is likely to be substantially greater than the interruption caused by simply displaying the prompt 410, since the user 405 must then communicate with the caller 403.

Thus, the user 405 may prefer to buffer the signal 402 from the acceptance of the request 404 rather than the detection of the request 404.

If the user 405 accepts the request 404, an accept message 406 or signal may be returned to the STB 102b. Alternatively, if the user 405 does not accept the request 404 (or if the request 404 is not accepted within an established time interval), a reject message 408 or signal may be returned to the STB 102b. Like the request 404, the accept and reject message 406, 408 may be embodied in different formats and configurations, depending on devices and software being used.

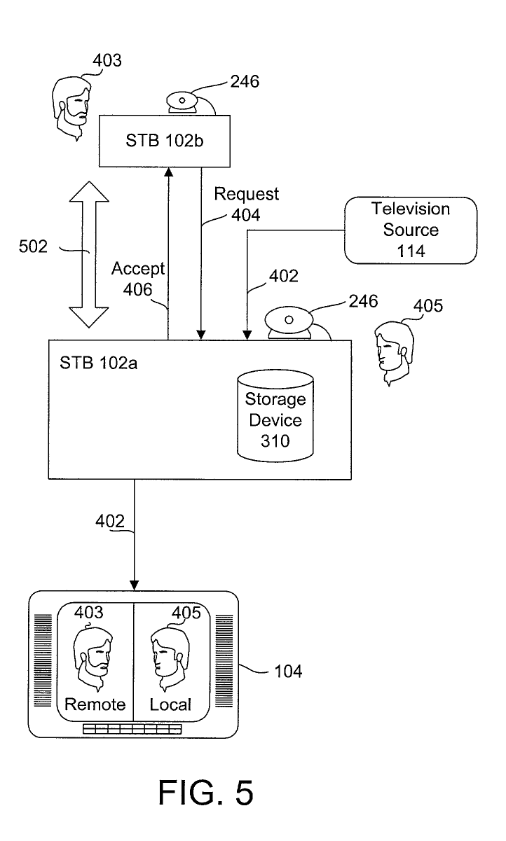

As shown in FIG. 5, the accept message 406 may be part of a handshaking process that continues until a communication channel 502 is established between the STBs 102a, 102b. The type of communication channel 502 established depends on the type of request 404 and the capabilities of the STBs 102a, 102b. For example, where both STBs 102a, 102b support videoconferencing, video communication may be established for a video communication request 404. However, where one or both STBs 102a, 102b do not support videoconferencing, only audio communication or text-based chat may be available.

Suppose, as in the depicted embodiment, that the request 404 is a request to establish two-way video communication. Further, suppose that the user 405 accepts the request 404. In one embodiment, the STB 102a launches a videoconferencing client, such as Microsoft NetMeeting®, to establish the communication channel 502 and manage two-way video communication.

A video camera 246 coupled to STB 102b captures video images of the caller 403 and sends them to the STB 102a for display. Likewise, a video camera 246 coupled to the STB 102a captures video images of the user 405 and sends them to the STB 102b for display. The television 104 may also display the video images of the user 405 using a split-screen or picture-in-picture (PIP) arrangement.

While the user 405 and caller 403 are engaged in communication, the STB 102a continues to buffer the television signal 402 in one embodiment. Advantageously, the user 405 may provide complete attention to the caller 403 without fear that he or she will miss any of the television broadcast.

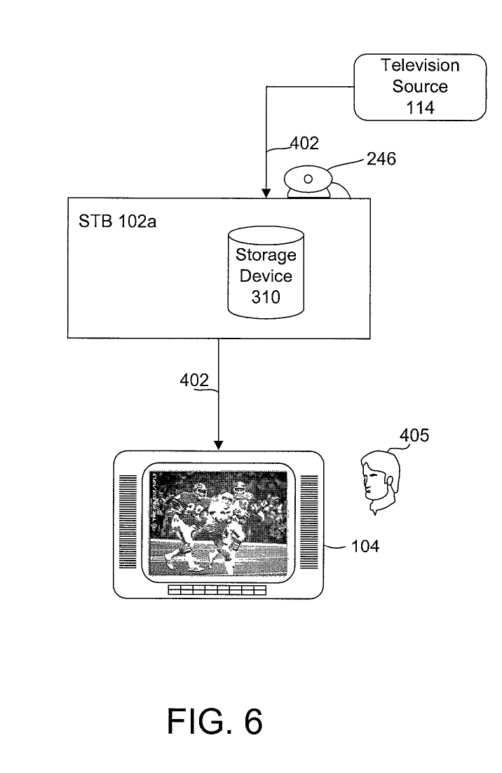

Either the user 405 or the caller 403 may terminate the communication 502 at any time. As shown in FIG. 6, when the communication channel 502 is terminated, the buffered television signal 402 is automatically played back, in one embodiment, from the point in time at which the request 404 was detected. Alternatively, the user 405 may configure the STB 102a to play back the buffered television signal 402 from the point in time at which the request was accepted. In either case, the STB 102a retrieves the buffered television signal 402 from the storage device 310, decodes the television signal 402, and displays the television signal 402 on the television 104. Like the automatic buffering described above, the automatic playback may commence without user intervention.

While the television signal 402 is being played back, the television signal 402 being received from the television source 114 continues to be buffered in the storage device 310. Thus, the displayed television signal 402 is time-shifted from the “live” television signal 402 by the period of the interruption caused by responding to the request 404 (e.g., answering or rejecting the call).

In certain configurations, a user 405 may “fast forward” the playback of the television signal 402 to catch up to the live broadcast. For example, the user 405 may press a “fast forward” button on the remote 106 to move quickly through commercial advertisements. Alternatively, a button may be provided to immediately display the live television signal 402 on the television 104 and terminate the buffering process.

Of course, the user 405 need not accept the request 404. In one embodiment, if the user 405 affirmatively rejects the request 404, the buffered television signal 402 may be played back from the point in time at which the request 404 was detected. Thus, a user 405 need not miss any of an ongoing television broadcast, even where the interruption was only long enough to decide to reject the request 404.

Those skilled in the art will recognize that communication requests 404 are only one type of interruption that occurs within an interactive television system 200. Interruptions may also occur, for instance, due to the user 405 responding to various interactive options, such as interactive polls, surveys, or commercial opportunities, or when the user 405 follows Internet links embedded in the television broadcast.

Interactive options are typically enabled by sending triggers, such as ATVEF (Advanced TV Enhancement Forum) triggers, to the STB 102a. Among other information, a trigger may contain a network address, such as a Universal Resource Locator (URL), that defines the location of content for the interactive option.

In one embodiment, the television signal 402 being currently displayed is also buffered in response to an interactive option becoming available or in response to the user 405 activating the interactive option. Thus, users 405 are able to respond to the polls or surveys, make an online purchase, or follow Internet links, while being able to view a television broadcast in its entirety.

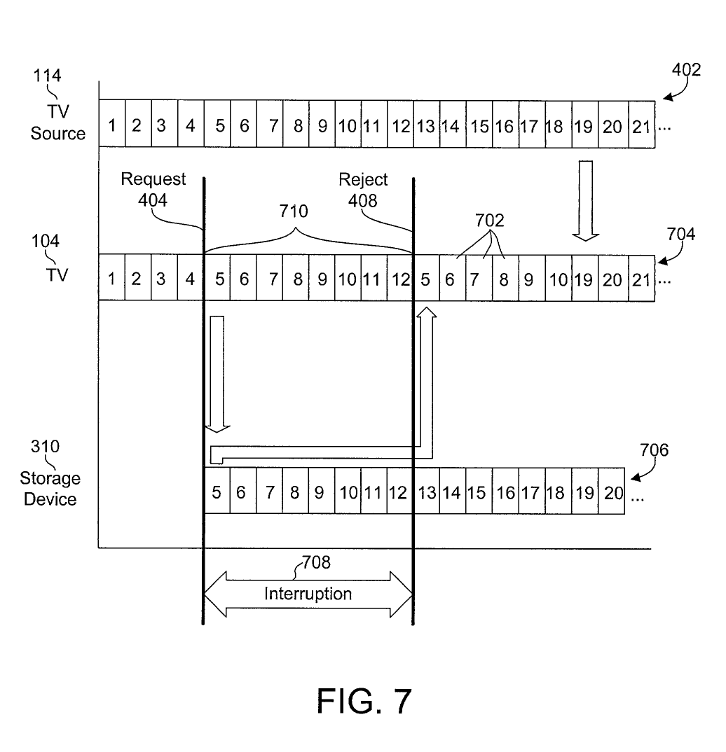

FIG. 7 is a timing diagram that further illustrates the buffering process. Each of the numbered blocks 702 represent a discrete time segment of the television signal 402. For example, a block 702 may correspond to one second, thirty seconds, one minute, etc. The number in each block 702 corresponds to the order in which the corresponding segments of the television signal 402 are broadcast by the television source 114.

A first sequence 704 of blocks 702 represents the television signal 402 as displayed on a television 104 or other display device. A second sequence 706 of blocks 702 represents the television signal 402 as buffered in a storage device 310.

In the depicted embodiment, once the request 404 is detected, the subsequent blocks 702 are buffered to the storage device 310 until, for example, a rejection message 408 is sent. The interval 708 between the request 404 and the rejection 408 corresponds to the length of the interruption. Note that the set 710 of blocks during the interruption may or may not be displayed by the television 104. For example, the display of the television signal 402 may be partially or wholly obscured by a prompt 410.

After the request 404 is rejected, playback of the buffered television signal 402 may commence with the first buffered block 702 (e.g., block “5” in FIG. 7) in the sequence 706 and may continue until the user 405 decides to “catch up” with the real-time signal 402 from the television source 114. For example, at block 19, the user 405 may decide to resume the display of the video signal 402 from the television source 114 rather than the storage device 310. Advantageously, this may occur during a commercial break or other segment of low interest to the user 405.

In one embodiment, the user 405 may catch up to the real-time signal 402 by pressing a button on the remote control 106. Alternatively, the user 405 may lose interest in the buffered television signal 402 and desire instead to jump directly to the real-time signal 402 by pressing an appropriate button on the remote control 106. In this case, the buffered signal 402 may be purged from the storage device 310 to provide capacity for subsequent buffering.

In some cases, the buffered television signal 402 may be played back at a modified rate, e.g., accelerated, slowed, paused, restarted, etc., in response to the user activating a transport control, such as a fast-forward button, a frame-advance button, a pause button, a restart button, etc. The transport control may be embodied, for example, as a physical button on the remote control 106 or a “soft button” displayed on the television 104.

Of course, the timing diagram of FIG. 7 illustrates only one possible embodiment of the invention. In other embodiments, for example, buffering may begin when a request 404 is accepted and played back from the point at which the request 404 was accepted.

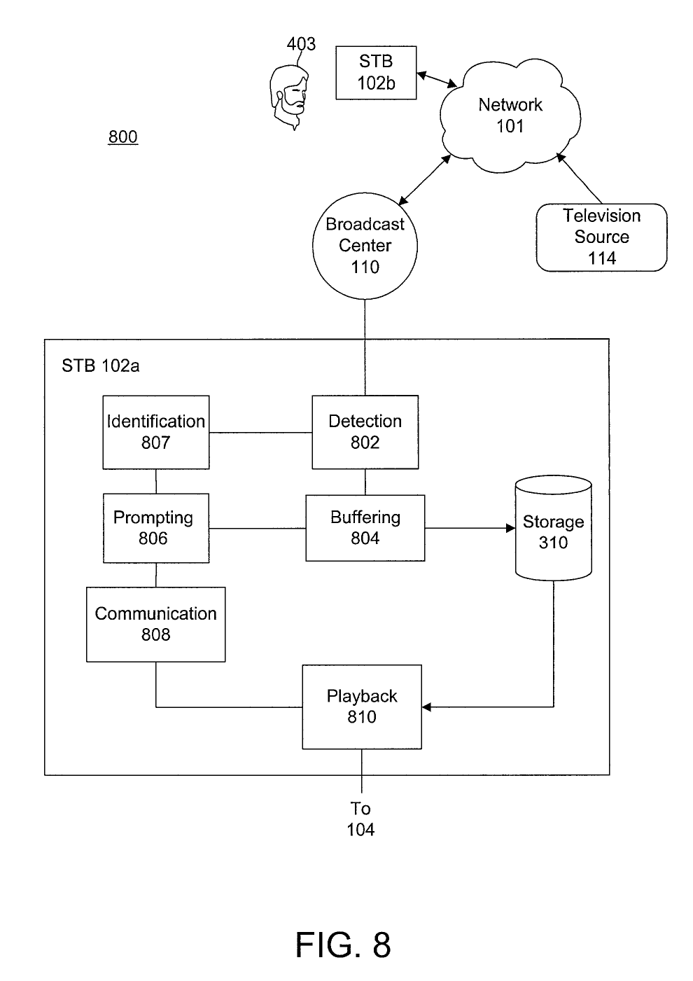

Referring now to FIG. 8, a system 800 for mitigating interruptions during a television broadcast 402 is illustrated. The depicted logical components may be implemented using one or more of the physical components shown in FIG. 3. Additionally, or in the alternative, various logical components may be implemented as software modules stored in the memory 306 and/or storage device 310 and executed by the CPU 312 . Those skilled in the art will recognize that various illustrated components may be combined together or integrated with standard components in various configurations without departing from the scope or spirit of the invention.

As noted above, a television source 114 may broadcast a television signal 402 to an STB 102a using a network 101 and one or more broadcast centers 110. The television signal 402 may be received by the network interface/tuner 302 of the STB 102a, as depicted in FIG. 3. Additionally, a caller's STB 102b may send a communication request 404 to the user's STB 102a.

In one embodiment, the system 800 includes an detection component 802, which detects the request 404, as described above in connection with FIG. 4. The detection component 802 may be implemented as a software module in communication with the network interface 302 of FIG. 3, which monitors incoming packets received from the network 101. Of course, a variety of other implementations are possible.

The system 800 may also include a buffering component 804 in communication with the detection component 802. In one implementation, when the detection component 802 detects a request 404, the buffering component 804 automatically begins to buffer the television signal 402 using a storage device 310, as described in connection with FIGS. 4, 5, and 7. The storage device 310 may include one or more hard disks drives or optical drives (CD-RW, DVD-RAM, etc.) or may even be implemented using random access memory (RAM).

In one configuration, the buffering component 804 is configured to encode (and preferably compress) the television signal 402 prior to storage thereof in the storage device 310. Various algorithms may be used for this purpose, such as MPEG-2. In alternative embodiments, the video signal 402 may be broadcast in a compressed format, in which case the buffering component 804 simply stores the video signal 402 in the storage device 310.

In the depicted embodiment, the buffering component 804 is in communication with a prompting component 806. As described in connection with FIG. 4, the prompting component 806 prompts the user 405 to accept or reject the request 404. For example, the prompting component 806 may display a prompt 410, such as a pop-up window, that notifies the user 405 of the incoming request 404 .

In one configuration, the prompt 410 identifies the caller 403. Accordingly, the prompting component 806 may interact with an identification component 807 in order to identify the caller 403. The caller 403 may be identified, in one embodiment, using information contained within the request 404. For example, the request 404 may include a name or network address of the caller 403. Alternatively, the request 404 may include a network address of the caller's STB 102b.

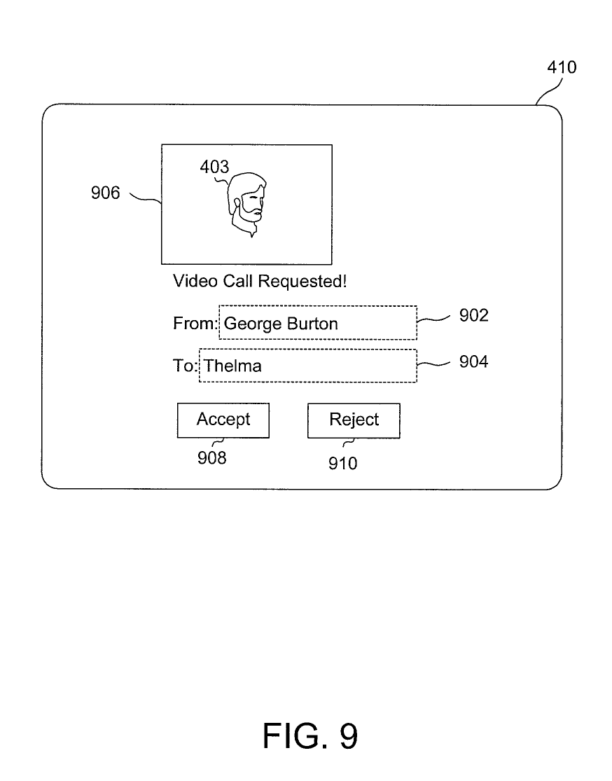

As shown in FIG. 9, the prompt 410 may include different types of information, which may vary depending on the type of communication request 404. The prompt 410 may include, for example, a caller identifier 902 and a recipient identifier 904, both of which may be derived from the request 404. A video window 906 may also be provided, which may include live or recorded video images of the caller 403. The additional information 902, 904, 906 provided in the prompt 410 allows the user 405 to quickly determine whether to accept or reject the request 404. Moreover, to facilitate a response from the user 405, the prompt 410 may include an accept button 908 and a reject button 910.

Referring again to FIG. 8, if the user 405 accepts the request 404, the prompting component 806 may signal a communication component 808 to establish a two-way communication channel 502 between the caller 403 and the user 405, as described in detail in connection with FIG. 5.

In one implementation, the communication component 808 manages the communication channel 502 from establishment to termination. Various systems are known for providing two-way communication, such as Microsoft Netmeeting®, CuSeeMe®, mIRC®, Microsoft MSN® Messenger Service, and the like.

If the user 405 rejects the request 404 (or the request 404 is not accepted within an established time interval), the communication component 808 may activate a playback component 810 to automatically play back the television signal 402 being buffered from a point in time at which the request 404 was detected.

As described above in connection with FIGS. 6-7, the playback component 810 plays back the buffered television signal 402 from the storage device 310. In certain embodiments, the playback component 810 may retrieve the television signal 402 from the storage device 310, decode the television signal 402, and display the television signal 402 on the television 104.

In an alternative embodiment, buffering may commence when the communication request 404 is accepted. For example, the communication component 808, rather than the detection component 802, may activate the buffering component 804 when the request 404 is accepted. In such an embodiment, the playback component 810 plays back the buffered television signal 402 from a point in time when the request 404 was accepted.

In yet another embodiment, the system 800 may be configured to allow a user 405 to initiate play back of the television signal 402 while a communication channel 502 is active with the caller 403. In this embodiment, a video signal received from the caller may be displayed in a Picture-in-Picture (PIP), split-screen, or multi-sectional configuration with the television signal 402.

Other types of communication may be more suited to being conducted during display of the television signal 402. For example, a text-based chat session may be easily conducted while the television signal 402 is being displayed on the television 104.

In still another embodiment, the system 800 may be configured to automatically buffer the television signal 402 when a user 405 initiates a request 404 for communication with a recipient (not shown). In this embodiment, the communication component 808 may signal to buffering component 804 to automatically begin buffering when the user's interactive television system 200 sends a communication request 404 to a remote device. Alternatively, the communication component 808 may cause the buffering component 804 to begin buffering when a communication channel 502 has been established. Similarly, in this embodiment, the communication component 808 may signal the play back component 810 to automatically play back the television signal 402 (from the point in time at which the request 404 as sent) when the request 404 is rejected or the communication channel 502 is terminated.

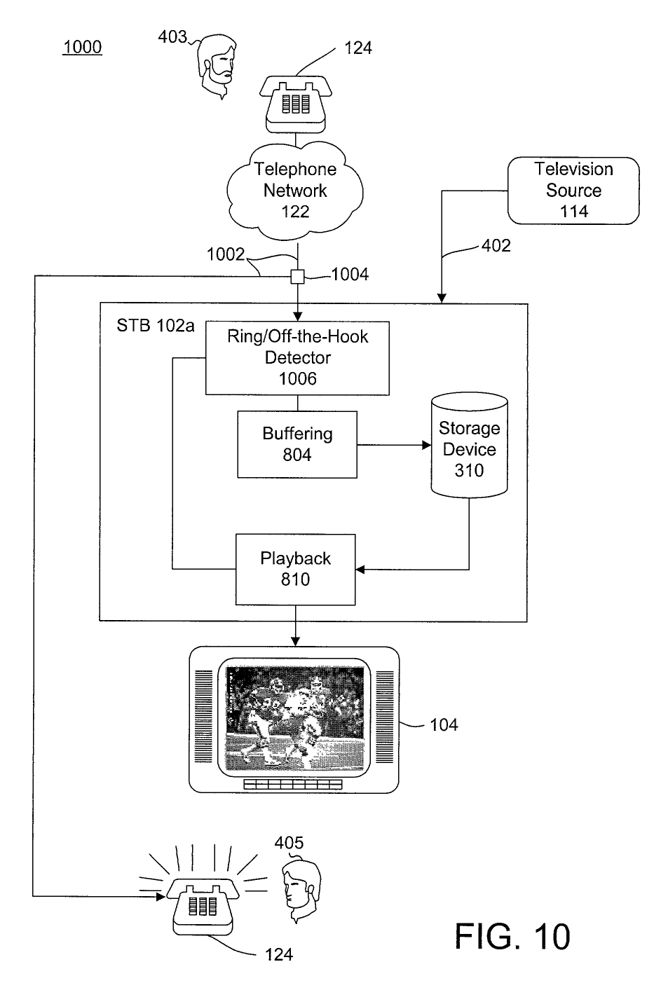

FIG. 10 illustrates an alternative system 1000 for mitigating interruptions during television viewing according to an embodiment of the present invention. In the depicted embodiment, an STB 102a is coupled to a telephone network 122 via a standard telephone line 1002. The telephone line 1002 may also be coupled to a standard telephone 124, which may be conveniently located near the user's viewing location. Both the telephone 124 and the STB 102a may be coupled to the telephone line 1002 using a standard line splitter 1004.

In one embodiment, the STB 102a includes a ring/off-the-hook detector 1006 for detecting a ring signal on the telephone line 1002 and/or for determining whether the telephone 124 of the user 405 is off-the-hook. Devices for ring detection and off-the-hook detection are well known in the telephony art. While the ring/off-the-hook detector 1006 is depicted as a single unit, those of skill in the art will recognize that separate components may be provided.

When the ring/off-the-hook detector 1006 detects a ring signal on the line 1002 (indicating an incoming telephone call), the buffering component 804 may begin to buffer the television signal 402 being currently viewed. Alternatively, buffering may begin when the ring/off-the-hook detector 1006 detects that the telephone 124 is off-the-hook (indicating that the user 405 has picked up the telephone receiver). In one embodiment, the television signal 402 may be muted or suppressed when an off-the-hook condition is detected.

If the user 405 does not answer the telephone 124 within an established time interval, the buffering may be terminated (or may never have begun in the buffer-on-acceptance embodiment). If, however, the user does answer the telephone 124, the buffering continues (or begins) until the user hangs up.

When the user hangs up, the ring/off-the-hook detector 1006 may detect that the telephone 124 is no longer off-the-hook. In one embodiment, the ring/off-the-hook detector 1006 then signals the playback component 810 to begin playing back the buffered television signal 402.

Thus, the system 1000 provides mitigation of interruptions caused by conventional telephones 124. Conventional Personal Video Recorders (PVRs) may allow the user 405 to “pause” the television signal 402. However, the process is manual. The user 405 must manually press a “pause” button located on the STB 102 and/or remote control 106. During this process, the user's attention is diverted and the user 405 will likely miss some portion of the television broadcast. By contrast, the system 1000, buffers the television signal 402 automatically upon detecting a ring signal or an off-the-hook condition. Additionally, the television signal 402 is played back automatically upon termination of the telephone call.

In an alternative embodiment, the television signal 402 may be buffered when a user desires to place a telephone call. In this embodiment, buffering and play back operate similar to the embodiment described above. The ring/off-the-hook detector 1006 signals the buffering component 804 to buffer the television signal 402 until the telephone 124 is no longer off-the-hook.

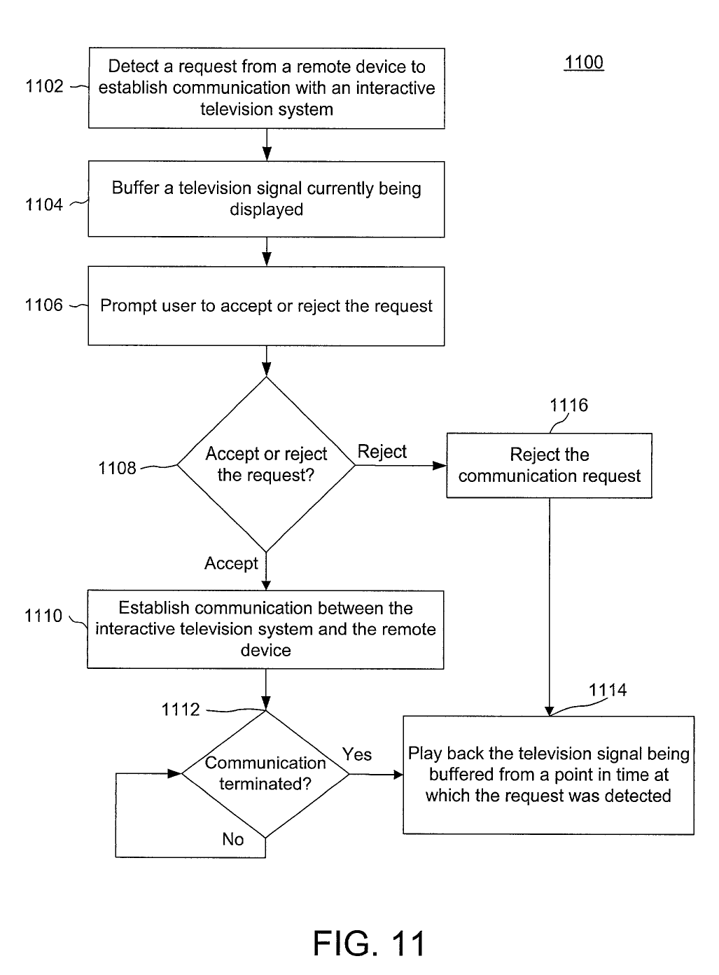

Referring now to FIG. 11, there is shown a flowchart of a method 1100 for mitigating interruptions during television viewing. The method 1100 begins by detecting 1102 a request 404 from a remote device to establish communication with an interactive television system 200 of a user. In one embodiment, a television signal 402 being currently displayed is immediately buffered 1104 to a storage device 310, while the user is prompted 1106 to accept or reject the request 404.

A determination 1108 is then made whether the user accepts or rejects the request 404. If the user accepts, communication is established 1110 between the remote device and the interactive television system 200. Thereafter, a determination 1112 is made whether the communication has been terminated. If so, the television signal 402 being buffered is played back 1114 from a point in time at which the request 404 was detected 1102. If not, the method returns to step 1112 to await the termination of the communication.

If the user rejects the request 404 in step 1106, the communication request 404 is rejected 1116. In certain configurations, the television signal 402 being buffered is then played back 1114 from a point in time at which the request 404 was detected.

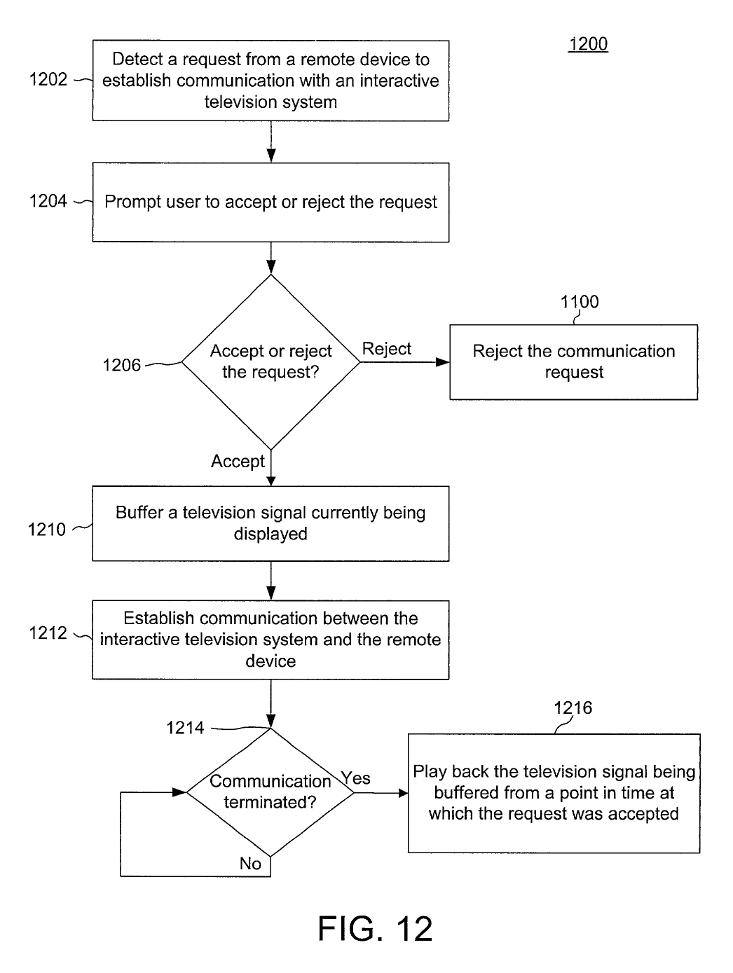

FIG. 12 illustrates an alternative method 1200 for mitigating interruptions during a television viewing. The method 1200 begins by detecting 1202 a request 404 from a remote device to establish communication 502 with an interactive television system 200 of a user. Thereafter, the user is prompted 1204 to accept or reject the request 404.

A determination 1206 is then made whether the user accepts or rejects the request 404. If the user rejects the request 404, the communication request 404 is rejected 1208. If, however, the user accepts of the request 404, a television signal 402 currently being displayed is buffered 1210 in a storage device 310. Thereafter, communication is established 1212 between the remote device and the interactive television system 200.

A determination 1214 is then made whether the communication has been terminated. If so, the television signal 402 being buffered is played back 1216 from a point in time at which the request 404 was accepted 1206. If not, the method 1200 returns to step 1214 to await termination of the communication.

Based on the foregoing, the present invention offers a number of advantages not available in conventional approaches. A user may respond to various interruptions, such as incoming communication requests, telephone calls, and the like, without fear of missing a television broadcast being viewed. Buffering and playback of the television broadcast occur automatically, allowing the user to fully concentrate on responding to the interruption.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. A method in an interactive television system for mitigating interruptions during television viewing, the method comprising:
receiving a television signal from a signal source;
displaying the television signal;
detecting an incoming telephone call at the interactive television system; and
automatically buffering the television signal for subsequent playback after the telephone call is terminated.

2. The method of claim 1, wherein detecting comprises detecting an incoming telephone call on a telephone line coupled to the interactive television system.

3. The method of claim 1, wherein detecting an incoming telephone call on a telephone line comprises detecting a ring signal on the telephone line.

4. The method of claim 1, wherein detecting an incoming telephone call comprises detecting an incoming Internet-based telephone call.

5. The method of claim 4, wherein the Internet-based telephone call comprises a Voice-over-IP (VoIP) call.

6. The method of claim 1, wherein the television signal is automatically buffered in response to detecting the incoming telephone call.

7. The method of claim 1, wherein the television signal is automatically buffered in response to a user answering the telephone call.

8. The method of claim 1, further comprising:
detecting a user answering the telephone call; and
in response to detecting the telephone call being terminated, playing back the television signal being buffered from a point in time at which the telephone call was detected.

9. The method of claim 8, wherein detecting a user answering the telephone call comprises detecting an off-the-hook condition on a telephone line coupled to the interactive television system.

10. The method of claim 1, further comprising:
detecting a user answering the telephone call; and
in response to detecting the call being terminated, playing back the television signal being buffered from a point in time at which the telephone call was answered.

11. The method of claim 1, further comprising:
in response to a user command, playing back the television signal being buffered while the telephone call is in progress.

12. The method of claim 1, wherein buffering comprises:
encoding the television signal; and
storing the encoded television signal in a storage device.

13. The method of claim 1, further comprising:
in response to the telephone call being terminated, automatically playing back the television signal being buffered; and
during automatic playback of the buffered television signal, resuming display of a real-time television signal from the signal source in response to a user command.

14. The method of claim 13, wherein resuming comprises:
playing back the buffered television signal at a modified rate in response to a transport control.

15. A method in an interactive television system for mitigating interruptions during television viewing, the method comprising:
receiving a television signal from a signal source;
displaying the television signal;
detecting an outgoing telephone call at the interactive television system; and
automatically buffering the television signal for subsequent playback after the telephone call is terminated.

16. The method of claim 15, wherein detecting an outgoing telephone call comprises detecting an off-the-hook condition on a telephone line coupled to the interactive television system.

17. The method of claim 15, wherein detecting an outgoing telephone call comprises detecting an outgoing Internet-based telephone call.

18. The method of claim 17, wherein the outgoing Internet-based telephone call comprises a Voice-over-IP (VoIP) call.

19. The method of claim 15, further comprising:
in response to detecting the telephone call being terminated, playing back the television signal being buffered from a point in time at which the outgoing telephone call was detected.

20. The method of claim 1, wherein buffering comprises:
encoding the television signal; and
storing the encoded television signal in a storage device.

21. An interactive television system for mitigating interruptions during television viewing, the system comprising:
a tuner that receives a television signal from a signal source;
a video controller that displays the television signal on a display device;
a detection component that detects an incoming telephone call at the interactive television system; and
a buffering component that automatically buffers the television signal for subsequent playback after the telephone call is terminated.

22. The system of claim 21, wherein the interactive television system is coupled to a telephone line, and wherein the detection component detects an incoming telephone call on the telephone line.

23. The system of claim 22, wherein the detection component comprises a ring detector that detects a ring signal on the telephone line.

24. The system of claim 22, wherein the detection component comprises an off-the-hook detector that detects an off-the-hook condition on the telephone line.

25. The system of claim 21, wherein the detection component detects an Internet-based telephone call.

26. The system of claim 25, wherein the Internet-based telephone call comprises a Voice-over-IP (VoIP) call.

27. The system of claim 21, wherein the buffering component automatically buffers the television signal in response to detecting the incoming telephone call.

28. The system of claim 21, wherein the buffering component automatically buffers the television signal in response to a user answering the telephone call.

29. The system of claim 21, wherein the detection component detects a user answering the telephone call, the system further comprising:
a playback component that, in response to detecting the telephone call being terminated, plays back the television signal being buffered from a point in time at which the telephone call was detected.

30. The system of claim 21, wherein the detection component detects a user answering the telephone call, the system further comprising:
a playback component that, in response to detecting the telephone call being terminated, plays back the television signal being buffered from a point in time at which the telephone call was answered.

31. The system of claim 21, further comprising:
a playback component that, in response to a user command, plays back the television signal being buffered while the telephone call is in progress.

32. The system of claim 21, wherein the buffering component comprises:
an encoder that encodes the television signal; and
a storage device that stores the encoded television signal.

33. The system of claim 21, further comprising:
a playback component that automatically plays back the television signal being buffered in response to the telephone call being terminated and, during automatic playback of the buffered television signal, resumes display of a real-time television signal from the signal source in response to a user command.

34. The system of claim 33, wherein the playback component plays back the buffered television signal at a modified rate in response to a transport control.

35. An interactive television system for mitigating interruptions during television viewing, the system comprising:
a tuner that receives a television signal from a signal source;
a video controller that displays the television signal on a display device;
a detection component that detects an outgoing telephone call at the interactive television system; and
a buffering component that automatically buffers the television signal for subsequent playback after the telephone call is terminated.

36. The system of claim 35, wherein the interactive television system is coupled to a telephone line, and wherein the detection component comprises an off-the-hook detector that detects an off-the-hook condition on the telephone line.

37. The system of claim 35, wherein the detection component detects an outgoing Internet-based telephone call.

38. The system of claim 37, wherein the outgoing Internet-based telephone call comprises a Voice-over-IP (VoIP) call.

39. The system of claim 35, further comprising:
a playback component that, in response to detecting the telephone call being terminated, plays back the television signal being buffered from a point in time at which the outgoing telephone call was detected.

40. The system of claim 21, wherein the buffering component comprises:
an encoder that encodes the television signal; and
a storage device that stores the encoded television signal.

41. A method in an interactive television system for mitigating interruptions during television viewing, the method comprising:
receiving a television signal from a signal source;
displaying the television signal on a television;
detecting an incoming telephone call on a telephone line coupled to the interactive television system;
automatically buffering the television signal;
detecting a user answering the telephone call; and
in response to the telephone call being terminated, playing back the television signal being buffered.

42. An interactive television system for mitigating interruptions during television viewing, the system comprising:
a tuner that receives a television signal from a signal source;
a video controller that displays the television signal on a television;
a detection component that detects an incoming telephone call on a telephone line coupled to the interactive television system;
a buffering component that automatically buffers the television signal; and
a playback component that, in response to the telephone call being terminated, automatically plays back the television signal being buffered.

43. An interactive television system for mitigating interruptions during television viewing, the system comprising:
means for receiving a television signal from a signal source;
means for displaying the television signal;
means for detecting an incoming telephone call at the interactive television system; and
means for automatically buffering the television signal for subsequent playback after the telephone call is terminated.
